(19) United States
(12) Patent Application Publication
(10) Pub. No.: US 2016/0328227 A1
(43) Pub. Date: Nov. 10, 2016

(54) Dynamically Applying A Software Patch To A Computer Program

(71) Applicant: HEWLETT PACKARD ENTERPRISE DEVELOPMENT LP, Houston, TX (US)

(72) Inventors: Deepti Kharbanda, Bangalore (IN); Mahesh Tavarekere Ranganathaiah, Bangalore (IN); Abhay Padlia, Bangalore (IN)

(21) Appl. No.: 15/110,661

(22) PCT Filed: Jan. 8, 2014
(86) PCT No.: PCT/US2014/010691

§ 371 Date: Jul. 8, 2016

(51) Int. Cl. G06F 9/445

(52) U.S. Cl. CPC G06F 8/65

(57) ABSTRACT

Provided is a method of dynamically applying a software patch to a computer program. A current version of a computer program is determined. Upon determination, compared to the current version, increasingly higher versions of the software patch are sequentially applied to the computer program, wherein the higher versions of the software patch are provided in form of a package.

### BACKGROUND

Computer programs installed in a computer system are typically updated by applying a software patch (or software patches). A software patch upon installation may provide protection against security threats, fix bugs, or generally improve the usability or performance of a computer program. Since a vulnerable computer program could cause a loss of valuable data, confidential information, downtime etc., software patches play an important role in keeping a computer program (and computer system) safe and up-to-date.

### BRIEF DESCRIPTION OF THE DRAWINGS

For a better understanding of the solution, embodiments will now be described, purely by way of example, with reference to the accompanying drawings, in which:

FIG. 1 illustrates a system for dynamically applying a software patch to a computer program, according to an example.

FIG. 2 illustrates a method of dynamically applying a software patch to a computer program, according to an example.

FIG. 3 illustrates a system for dynamically applying a software patch to a computer program, according to an example.

### DETAILED DESCRIPTION OF THE INVENTION

Software developers often release a series of security and feature patches to address various requirements or bugs found in the operating environment of a customer's computer systems. Most of these patch update mechanisms replace a defective binary on a target system and require a reboot or a restart of the affected computer application to bring the fix into effect. This brings the system up-to-date to the latest version of the target binary. These mechanisms are known as static patching. Thus, in static patching, a software update typically requires stopping and restarting an application. However, there are many scenarios where computer systems cannot afford to halt service. Dynamic or online patching allows a computer program of a running system to be dynamically updated with new code and data with-out requiring a reboot or downtime. Dynamic patching permits programs to be updated while they run.

Present online patching solutions provide dynamic patches which limit the patching scope to the current patch version. These patches update a target binary from a previous patch level to the current patch level. For example, a target system (presently at patch level 0) may directly be updated to the current patch level (for example, patch level 3). However, there may be a scenario where a target system (presently at patch level 0) may need to be updated to a higher patch level (for example, patch 1) before the latest online patch can be applied (for example, patch 2) to it. When dealing with a complex system setup and multiple online patches, this scenario can pose a big challenge to an administrator to bring the system up-to-date with the latest dynamic patch fix version, without opting for a reboot or application restart.

Proposed solution provides a method of dynamically applying a software patch to a computer program. Proposed solution packages multi-versions of software patches into a package for delivering an online patching fix. A current version of a computer program in a computer system is determined and, upon such determination, increasingly higher versions of the software patch are sequentially applied to the computer program until the current version. Proposed solution provides a dynamically loadable module which carries only the changes made in each patch level from its previous. The module is dynamically loaded into the memory of the computer system thereby providing the changed function for the patching infrastructure to access. On successful patching, the changed function in the newly loaded module is accessed thereon instead of its older version in the memory. Thus, the patches are applied in such a way that an administrator (or another user) can apply the patches from any lower patch level that supports dynamic patching. Further, the administrator can also roll back a patch to a desired previous patch level.

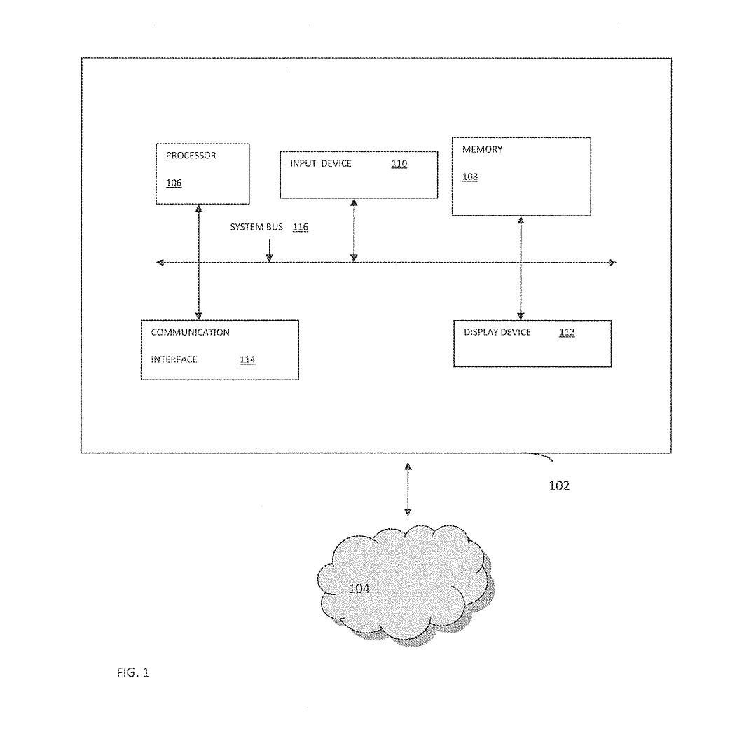

FIG. 1 illustrates a system 100 for dynamically applying a software patch to a computer program, according to an example. System includes computer system 102 and computer network 104.

Computer system 102 may include, by way of example, a computer server, desktop computer, notebook computer, tablet computer, mobile phone, personal digital assistant (PDA), or the like. Computer system 102 may be a computer server, desktop computer, notebook computer, tablet computer, mobile phone, personal digital assistant (PDA), or the like. Computer system 202 may include processor 106, memory 108, input device 110, display device 112, and a communication interface 114. The components of the computer system 102 may be coupled together through system bus 116.

Processor 106 may include any type of processor, microprocessor, or processing logic that interprets and executes instructions.

Memory 108 may include a random access memory (RAM) or another type of dynamic storage device that may store information and instructions non-transitorily for execution by processor 106. For example, memory 108 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. In an example, memory 108 includes a computer program (or computer programs). The computer program may include an operating system, application software (machine-executable instructions), library and the like. Further, a computer program installed on computer system may be a first version of the program (i.e. patch level 0) or a subsequent higher version of the program (such as patch level 1, 2, 3, and so and so forth).

Input device 110 may include a keyboard, a mouse, a touch-screen, or other input device. Display device 112 may include a liquid crystal display (LCD), a light-emitting diode (LED) display, a plasma display panel, a television, a computer monitor, and the like.

Communication interface 114 may include any transceiver-like mechanism that enables computing device 102 to communicate with other devices and/or systems via a communication link. Communication interface 114 may be a software program, a hard ware, a firmware, or any combination thereof. Communication interface 114 may provide communication through the use of either or both physical and wireless communication links. To provide a few non-limiting examples, communication interface 114 may be an Ethernet card, a modem, an integrated services digital network (“ISDN”) card, etc.

In an implementation, user computer system is communicatively coupled to computer network 104, which may be wired or wireless (for example, a telecom network). Computer network 104 may be a public network such as the Internet, or a private network such as an intranet. Computer network 104 may host a computer patch (or computer patches) which may be downloaded from computer network 104 by computer system 102. In an example, various computer patch versions that may be applied to a computer program are bundled together in form of a package which is downloadable from computer network as well. In an example, a computer patch includes a Dynamically Loadable Kernel Module (DLKM). A DLKM module is a modularly-packaged module with the capability to be dynamically loaded into a running kernel. In the kernel configuration context, this means that the DLKM module uses its own master and system files and contains the module wrapper code and additional data structures that provide the dynamic loading and unloading ability. In an example, a DLKM module includes a current version of the fix and meta-data. In an example, the fix includes a current version of the changed functions. In an example, the meta-data includes a list of functions that are being patched in a target computer system, any other data (such as patch level names, etc.) that a patching infrastructure (explained below) may need for carrying out the process, and information regarding the sequence in which the higher versions of a software patch need to be installed on a target system.

A Dynamically Loadable Kernel Modules (DLKM) Infrastructure may be needed for implementing a DLKM module. A Dynamically Loadable Kernel Modules (DLKM) Infrastructure is an operating system feature that allows “DLKM Enabled” kernel modules to be dynamically loaded into, or unloaded from, the operating system kernel without having to re-link the entire kernel or reboot the system. The DLKM feature not only provides the infrastructure to load kernel modules into a running system, but it also allows a kernel module to be statically linked when rebuilding the kernel. A DLKM infrastructure specifies that a kernel module must be packaged modularly with at least its own master and system files, its own mod.o object file that implements only that module and the mod.o object file must contain the Module Wrapper code. In an example, a Dynamically Loadable Kernel Modules (DLKM) Infrastructure is present on computer system 102.

It would be appreciated that the components depicted in FIG. 1 are for the purpose of illustration only and the actual components (including their number) may vary depending on the computing architecture deployed for implementation of the proposed solution.

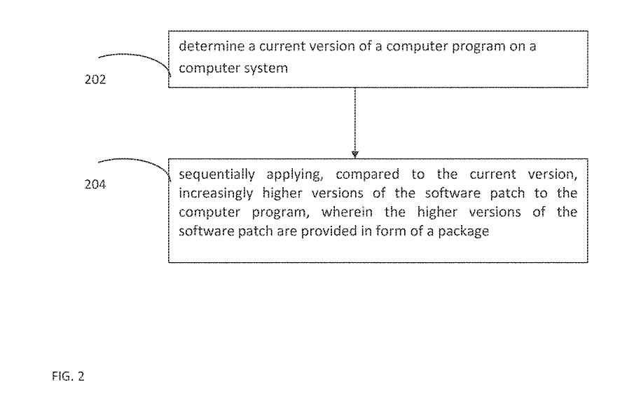

FIG. 2 illustrates a method of dynamically applying a software patch to a computer program, according to an example.

At block 202, a current version of a computer program present (or installed) in a computer system is determined. In an example, a current version of a computer program installed in a computer system is automatically determined by a patching infrastructure (such as a Dynamically Loadable Kernel Modules (DLKM) Infrastructure) which may be present on a computer network (such as the Internet). In this case, the computer system which is hosting a current version of the computer program may be communicatively coupled to said computer network.

At block 204, upon determination of the current version of a computer program present in a computer system, increasingly higher versions of a software patch are sequentially applied to the computer program. In other words, by way of an illustration, if the current version of a computer program in a computer system, for instance, is at patch level 0 then subsequent higher versions of a software patch (such as patch level 1, 2, 3, etc.) meant for applying onto the computer program (for instance, to bring it up-to-date to the latest version) would be applied in a sequential manner beginning with immediately succeeding patch level i.e., in this case, patch level 1->patch level 2->patch level 3, and so and so forth. Increasingly higher versions of a software patch may be sequentially applied to the computer program till it gets updated with the latest version of the software patch.

As mentioned earlier, a software patch may include a Dynamically Loadable Kernel Module (DLKM) that may include a current version a current version of the changed functions and meta-data. For instance, a Dynamically Loadable Kernel Module (DLKM) for a dynamic software patch level 1 is created by encapsulating only the delta of changed or fixed code of patch level 0 and patch level 1 into a module format. In an example, said DLKM module may be named as <patch_1><DLKM_name>. Thus, the dynamic patch level 1 contains <patch_1><DLKM_name> and relevant metadata information.

Similarly, a DLKM for dynamic software patch level 2 is created by encapsulating only the delta of changed or fixed code of patch level 1 and patch level 2 into a module format. Such DLKM module may be named as <patch_2><DLKM_name>. The dynamic patch level 2 now contains <patch_1><DLKM_name>, <patch_2><DLKM_name> and relevant metadata information.

In a like manner, further DLKMs for higher software patch levels may be created wherein each of the higher versions of the software patch includes updates or changes specific to each of the higher versions of the software patch along with updates from all preceding versions of the software patch.

In an implementation, the higher versions of the software patch are bundled together in form of a package, which may be present on a computer network (such as the Internet). In an example, the higher versions of the software patch are sequentially extracted and applied from the package.

In an implementation, various versions (or levels) of a software patch applied to a computer program may be removed or un-installed in a reverse chronological order of installation. This helps an administrator in removing dynamically installed changes in step by step manner.

It may be noted that a system reboot or restart of a computer program is not needed while sequentially increasingly higher versions of a software patch are applied to a computer program. likewise, a reboot or restart of the computer system is not needed while sequentially un-installing the higher versions of a software patch in a reverse chronological order of installation,

FIG, 3 illustrates an example system 300 for synchronizing a cloud service template with an infrastructure template, according to an example. System 300 includes a processor 302 that executes instructions in a memory 304. The memory 304 includes a patch module 306 to determine a current version of a computer program, and sequentially apply, compared to the current version, increasingly higher versions of the software patch to the computer program, wherein each of the higher versions of the software patch includes updates specific to each of the higher versions of the software patch along with updates from all preceding versions of the software patch.

Proposed solution provides a host of advantages by packaging a software patch with successive patch levels into a bundle. For instance, it relieves the administrator from the responsibility of sorting out patch interdependencies between different patch levels. Additionally, in the event, the customer systems are at different patch levels, a legacy cumulative patch would limit the target levels on which the patch could be installed. For example, if a customer system is at patch level 1 and a dynamic patch containing cumulative fixes from patch level 0 to patch level 2 is provided, the patch cannot be applied without tweaks or not applied at all. Further, the proposed solution with logically segregated fixes provides granularity to uninstall or rollback patches in reverse order of installation to patch level 0 or restore to a desired previous patch level on target system. An administrator is not forced to remove an entire patch bundle. The method also simplifies the patch creation process since a new patch is created with only changes from the previous patch.

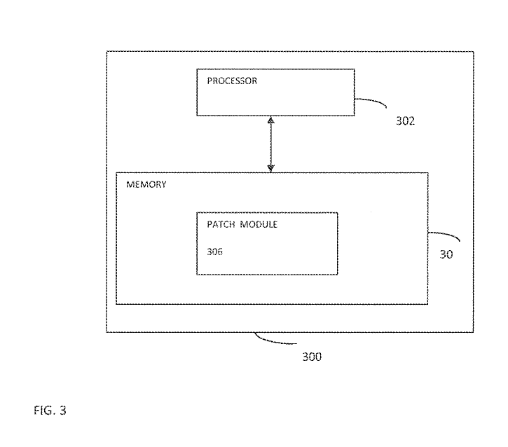

For the purpose of simplicity of explanation, the example method of FIG. 2 is shown as executing serially, however it is to be understood and appreciated that the present and other examples are not limited by the illustrated order. The example systems of FIGS. 1 and 3, and method of FIG. 2 may be implemented in the form of a computer program product including computer-executable instructions, such as program code, which may be run on any suitable computing environment in conjunction with a suitable operating system such as, but not limited to, Microsoft Windows, Linux or UNIX operating system. Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and be executed by a processor.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system,

It would be appreciated that the system components depicted in the illustrated figures are for the purpose of illustration only and the actual components may vary depending on the computing system and architecture deployed for implementation of the present solution. The various components described above may be hosted on a single computing system or multiple computer systems, including servers, connected together through suitable means.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

1. A method of dynamically applying a software patch to a computer program, comprising:
determining a current version of the computer program on a computer system; and
sequentially applying, compared to the current version, increasingly higher versions of the software patch to the computer program, wherein the higher versions of the software patch are provided in form of a package.

2. The method of claim 1, wherein a system reboot or restart of the computer program is not needed while sequentially applying increasingly higher versions of the software patch to the computer program.

3. The method of claim 1, wherein each of the higher versions of the software patch includes updates specific to each of the higher versions of the software patch along with updates from all preceding versions of the software patch.

4. The method of claim 1, further comprising applying a latest version of the software patch to the computer program.

5. The method of claim 1, further comprising sequentially extracting the higher versions of the software patch from the package.

6. The method of claim 1, further comprising sequentially uninstalling the increasingly higher versions of the software patch in reverse chronological order to desired level.

7. The method of claim 1, wherein the package includes meta-data information describing installation sequence of the higher versions of the software patch.

8. The method of claim 1, further comprising packaging each of the higher versions of the software patch into a module containing updates pertaining to a particular version along with updates from all preceding versions of the software patch.

9. A system, comprising:
a computer system, wherein the computer system includes a version of a computer program; and
a patch module to determine the version of the computer program and sequentially installing, compared to the current version, increasingly higher versions of a software patch, wherein a system reboot or restart of the computer program is not needed while sequentially applying increasingly higher versions of the software patch to the computer program.

10. The system of claim 9, wherein each of the higher versions of the software patch includes a module containing updates specific to each of the higher versions of the software patch along with updates from all preceding versions of the software patch.

11. The system of claim 10, wherein the module is a Dynamically Loadable Kernel Module (DLKM).

12. The system of claim 9, wherein the higher versions of the software patch are provided in form of an online package.

13. The system of claim 9, wherein the software patch is downloaded from the internet.

14. The system of claim 9, wherein the software patch is a new or an updated binary file.

15. A non-transitory processor readable medium, the non-transitory processor readable medium comprising machine executable instructions, the machine executable instructions when executed by a processor causes the processor to:
determine a current version of a computer program; and
sequentially apply, compared to the current version, increasingly higher versions of the software patch to the computer program, wherein each of the higher versions of the software patch includes updates specific to each of the higher versions of the software patch along with updates from all preceding versions of the software patch.
